(19) United States
(12) Patent Application Publication
(10) Pub. No.: US 2024/0003738 A1
(43) Pub. Date: Jan. 4, 2024

(54) POSITION SPECIFYING SYSTEM, VIBRATION GENERATOR, AND POSITION SPECIFYING METHOD

(71) Applicant: NEC Corporation, Minato-ku, Tokyo (JP)

(72) Inventor: Tadayuki Iwano, Tokyo (JP)

(73) Assignee: NEC Corporation, Minato-ku, Tokyo (JP)

(21) Appl. No.: 18/038,146

(22) PCT Filed: Nov. 27, 2020
(86) PCT No.: PCT/JP2020/044161

§ 371 Date: May 22, 2023

(51) Int. Cl. G01H 9/00

(52) U.S. Cl. CPC G01H 9/004

(57) ABSTRACT

A position specifying system according to the present disclosure includes: a position information acquisition unit (31) that acquires position information; a vibration generation unit (32) that generates vibration including the position information; an optical fiber (10) that detects the vibration; a communication unit (21) that receives an optical signal including the position information included in the vibration; a distance specifying unit (22) that specifies, based on the optical signal, a distance of the optical fiber (10) from a location of the communication unit (21) to a location where the optical fiber (10) detects vibration; and a position specifying unit (23) that specifies, based on the optical signal, the position information included in the optical signal and stores the distance and the position information in association with each other.

### TECHNICAL FIELD

The present disclosure relates to a position specifying system, a vibration generator, and a position specifying method.

### BACKGROUND ART

Optical fiber sensing techniques are characterized in that an optical fiber detects an effect (e.g., sound, vibration, and temperature) of an event occurring in the vicinity of the optical fiber, and a sensing device (e.g., a distributed fiber optical sensor (DFOS)) is able to specify the event that occurs, based on the detected effect.

However, when an existing optical fiber is used, although a distance of the optical fiber from a location of the sensing device to a location where the optical fiber detects sound, vibration, or temperature may be specified, a position on a map where the optical fiber detects sound, vibration, or temperature cannot be specified. Therefore, it is not possible to specify the position on the map where the event occurs. Accordingly, it is necessary to acquire position information of an installation position of the existing optical fiber.

Hereinafter, an example of a position specifying system according to the related art for specifying position information of an installation position of an existing optical fiber will be described with reference to FIG. 1.

In the position specifying system illustrated in FIG. 1, a vibration generator 300 which has a function of generating vibration and a global positioning system (GPS) function is used. The vibration generator 300 is configured to be movable by being carried by a user or mounted on a moving body such as a vehicle.

The vibration generator 300 applies vibration to an optical fiber 100 at any location.

A sensing device 200 causes pulsed light to enter the optical fiber 100, and receives, as an optical signal, backscattered light generated when the pulsed light is transmitted through the optical fiber 100. At this time, vibration detected by the optical fiber 100 is superimposed on the optical signal.

Upon receiving the optical signal on which the vibration is superimposed, the sensing device 200 acquires, from the vibration generator 300 via a network 400, position information representing the latitude and longitude of the vibration generator 300 at a time when the vibration generator 300 applied the vibration. Therefore, the sensing device 200 has time synchronization with the vibration generator 300 in advance.

Further, the sensing device 200 is capable of specifying a distance of the optical fiber 100 from a location of the sensing device 200 to a location where the optical fiber 100 detects the vibration, based on a time difference between a time when the pulsed light is caused to enter the optical fiber 100 and a time when the optical signal on which the vibration is superimposed is received from the optical fiber 100.

The sensing device 200 stores the distance of the optical fiber 100 from the location of the sensing device 200 to the location where the optical fiber 100 detects the vibration, and position information of the vibration generator 300 at a time when the vibration generator 300 applied the vibration, in association with each other. As a result, the sensing device 200 is able to acquire position information of an installation position of the optical fiber 100.

By performing the above-described operation in advance at a plurality of locations while moving the vibration generator 300, the sensing device 200 is able to acquire position information with respect to each distance of the optical fiber 100. Thereby, the sensing device 200 is able to accurately acquire a position at which the optical fiber 100 detects an effect (e.g., sound, vibration, and temperature) of an event occurring in the vicinity of the existing optical fiber 100, and is also able to display such a position on a map.

As another related art, Patent Literature 1 discloses a technique of specifying a position represented by an optical fiber length (length from an end portion of an optical fiber) of a manhole by measuring a temporal change in scattered light from an optical fiber when striking force is applied to a cover of the manhole on a path of the optical fiber.

### CITATION LIST

### Patent Literature

[Patent Literature 1] Japanese Unexamined Patent Application Publication No. 2020-052030

### SUMMARY OF INVENTION

### Technical Problem

As described above, in the related art illustrated in FIG. 1, it is possible to acquire position information of the installation position of the optical fiber 100.

However, in the related art illustrated in FIG. 1, since the sensing device 200 needs to synchronize time with the vibration generator 300, there is a problem that a mechanism and time for time synchronization are required.

Further, in the related art illustrated in FIG. 1, a network 400 that transmits position information and information for time synchronization between the sensing device 200 and the vibration generator 300 is required. However, the network 400 is required to have real-time properties for real-time position specifying, and there is also a problem that it is difficult to establish such a network environment.

Further, the related art disclosed in Patent Literature 1 is a technique of specifying a position represented by an optical fiber length of a manhole, and is not a technique for specifying position information of an installation position of an optical fiber.

An object of the present disclosure is to provide a position specifying system, a vibration generator, and a position specifying method that solve the above-described problems and are capable of easily specifying position information of an installation position of an optical fiber.

### Solution to Problem

A position specifying system according to one aspect includes:
a position information acquisition unit configured to acquire position information;
a vibration generation unit configured to generate vibration including the position information;
an optical fiber configured to detect the vibration;
a communication unit configured to receive an optical signal including the position information included in the vibration;
a distance specifying unit configured to specify, based on the optical signal, a distance of the optical fiber from a location of the communication unit to a location where the optical fiber detects vibration; and
a position specifying unit configured to specify, based on the optical signal, the position information included in the optical signal and store the distance and the position information in association with each other.

A vibration generator according to one aspect includes:
a position information acquisition unit configured to acquire position information; and
a vibration generation unit configured to apply vibration including the position information to an optical fiber.

A position specifying method according to one aspect is a position specifying method to be performed by a position specifying system, and includes:
a step of acquiring position information;
a vibration generating step of generating vibration including the position information;
a step of detecting the vibration by use of an optical fiber;
a step of receiving an optical signal including the position information included in the vibration by use of a communication unit;
a distance specifying step of specifying, based on the optical signal, a distance of the optical fiber from a location of the communication unit to a location where the optical fiber detects vibration; and
a position specifying step of specifying, based on the optical signal, the position information included in the optical signal and storing the distance and the position information in association with each other.

### Advantageous Effects of Invention

According to the above-described aspects, it is possible to provide a position specifying system, a vibration generator, and a position specifying method that are capable of easily specifying position information of an installation position of an optical fiber.

### BRIEF DESCRIPTION OF DRAWINGS

FIG. 1 is a diagram illustrating a configuration example of a position specifying system according to a related art;

FIG. 2 is a diagram illustrating a configuration example of a position specifying system according to an example embodiment;

FIG. 3 is a diagram illustrating an example of vibration characteristics of an optical signal;

FIG. 4 is a diagram illustrating an example of two frequencies associated to latitude and longitude of the current position of a vibration generator, specified by a position specifying unit according to the example embodiment;

FIG. 5 is a diagram illustrating an example of an installation route of an optical fiber, specified by the position specifying unit according to the example embodiment;

FIG. 6 is a flowchart illustrating an example of a flow of an operation of the position specifying system according to the example embodiment;

FIG. 7 is a diagram illustrating an example of an excess portion of an optical fiber; and

FIG. 8 is a block diagram illustrating an example of a hardware configuration of a computer that implements a sensing device according to the example embodiment.

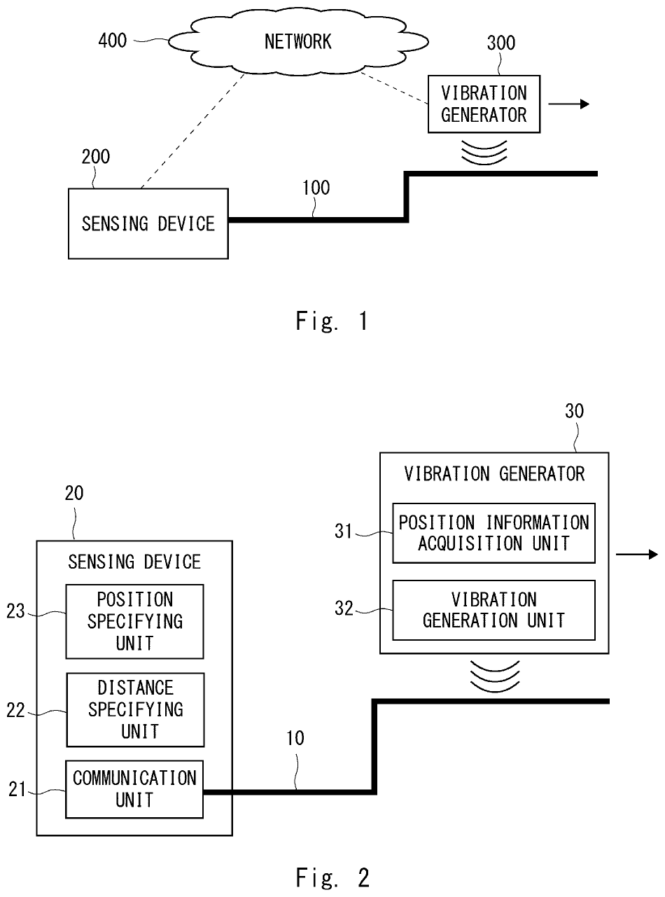

### EXAMPLE EMBODIMENT

Hereinafter, example embodiments of the present disclosure will be described with reference to the drawings. Note that the following description and the drawings are omitted and simplified as appropriate for clarity of description. In the following drawings, the same elements are denoted by the same reference signs, and redundant descriptions are omitted as necessary.

### Example Embodiments

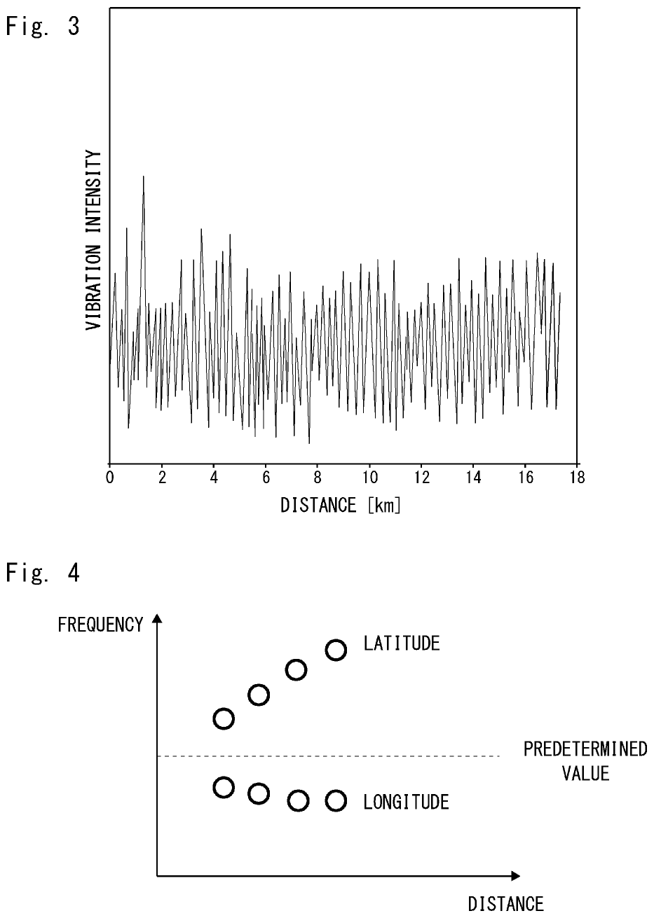

FIG. 2 illustrates a configuration example of a position specifying system according to the present example embodiment.

As illustrated in FIG. 2, the position specifying system according to the present example embodiment includes an optical fiber 10, a sensing device 20, and a vibration generator 30. The sensing device 20 includes a communication unit 21, a distance specifying unit 22, and a position specifying unit 23, and the vibration generator 30 includes a position information acquisition unit 31 and a vibration generation unit 32.

One end of the optical fiber 10 is connected to the communication unit 21 inside the sensing device 20. In the present example embodiment, it is assumed that the optical fiber 10 is an existing optical fiber being used for both communication and sensing. However, the optical fiber 10 may be an optical fiber dedicated to sensing, or may be a newly installed optical fiber. In a case where the optical fiber 10 is an optical fiber being used for both communication and sensing, an optical signal for sensing is demultiplexed by a filter (not shown) at a preceding stage of the communication unit 21 so that only the optical signal for sensing can be received by the communication unit 21.

The vibration generator 30 is configured to be movable by any method. For example, the vibration generator 30 may be moved by being carried by a user or by being mounted on a moving body such as a vehicle, but the method of moving the vibration generator 30 is not particularly limited.

The position information acquisition unit 31 has, for example, a GPS function, and acquires position information indicating the latitude and longitude of the current position of the vibration generator 30.

The vibration generation unit 32 generates vibration including the position information acquired by the position information acquisition unit 31.

Hereinafter, the vibration generation unit 32 will be described in detail.

The vibration generation unit 32 has a characteristic of changing the frequency of a vibration to be generated, based on the position information of the current position of the vibration generator 30 acquired by the position information acquisition unit 31. For example, the vibration generation unit 32 may simultaneously generate vibrations of two frequencies including vibration of a first frequency associated to latitude and vibration of a second frequency associated to longitude, or may generate such vibrations at different timings.

The vibration generation unit 32 applies, to the optical fiber 10, vibrations of two frequencies associated to the latitude and longitude of the current position of the vibration generator 30. As will be described later, by specifying vibrations of two frequencies applied to the optical fiber 10, the sensing device 20 becomes capable of specifying the position information of the current position of the vibration generator 30.

Here, it is assumed that the first frequency associated to the latitude and the second frequency associated to the longitude do not overlap each other. Further, it is assumed that the first frequency and the second frequency are frequencies identifiable by the sensing device 20.

Further, for the optical fiber 10 laid on the ground, the vibration generation unit 32 applies vibration on the ground, and for the optical fiber 10 buried underground, applies vibration from above the ground toward underground.

In the digital national land information, latitude and longitude are used as coordinate systems, wherein the east longitude is X, the north latitude is Y, and the east longitude and the north latitude are expressed in units of 0.1 second. The origin of the coordinate system is 0 degrees east longitude and 0 degrees north latitude. As one example, when the east longitude is 130 degrees 30 minutes 30 seconds and the north latitude is 48 degrees 30 minutes 30 seconds, the coordinate values of the X coordinate and the Y coordinate in the digital national land information data file are respectively as follows.

X coordinate=4698300{=(130 degrees×60 minutes×60 seconds+30 minutes×60 seconds+30 seconds)×10}

Y coordinate=1746300{=(48 degrees×60 minutes×60 seconds+30 minutes×60 seconds+30 seconds)×10}

The sensing device 20 may be implemented by, for example, DFOS.

The communication unit 21 causes pulsed light to enter the optical fiber 10, and receives, as an optical signal, backscattered light generated when the pulsed light is transmitted through the optical fiber 10.

When the vibration generation unit 32 generates vibration in the vicinity of the optical fiber 10, the vibration is applied to the optical fiber 10. As a result, characteristics (for example, a wavelength) of the optical signal transmitted through the optical fiber 10 changes. Therefore, the optical fiber 10 is able to detect the vibration generated by the vibration generation unit 32.

At this time, as described above, the vibration generation unit 32 generates vibrations of two frequencies associated to the latitude and longitude of the current position of the vibration generator 30. In other words, the vibration generation unit 32 generates vibration including position information of the current position of the vibration generator 30. Therefore, the optical signal received by the communication unit 21 includes the position information of the current position of the vibration generator 30.

Therefore, the position specifying unit 23 is able to specify the two frequencies by analyzing the frequency characteristics of the optical signal received by the communication unit 21. As a result, the position specifying unit 23 is capable of specifying the current position of the vibration generator 30 associated to the two frequencies, that is, the latitude and longitude of the position at which the optical fiber 10 detects the vibration.

Further, the distance specifying unit 22 is able to specify the distance of the optical fiber 10 from the location of the sensing device 20 (the communication unit 21) to the location where the optical fiber 10 detects the vibration, based on the time difference between the time when the communication unit 21 causes the pulsed light to enter the optical fiber 10 and the time when the communication unit 21 receives, from the optical fiber 10, the optical signal including the position information included in the vibration.

Therefore, the position specifying unit 23 stores the distance of the optical fiber 10 from the location of the sensing device 20 to the location where the optical fiber 10 detects the vibration and the position information included in the detected vibration in association with each other. Thereby, the position specifying unit 23 is able to specify the position information of the installation position of the optical fiber 10.

Hereinafter, an operation of the position specifying system according to the present example embodiment will be described by using specific examples.

For example, it is assumed that the vibration generation unit 32 generates vibration in the vicinity of a distance of 1 km of the optical fiber 10. FIG. 3 illustrates an example of the vibration characteristics of an optical signal received by the communication unit 21 at this time. In FIG. 3, the horizontal axis represents the distance of the optical fiber 10, and the vertical axis represents the vibration intensity.

In the example of FIG. 3, a peak in the vibration intensity occurs in the vicinity of a distance of 1 km of the optical fiber 10. Therefore, the position specifying unit 23 specifies two frequencies associated to the latitude and longitude of the current position of the vibration generator 30 by analyzing the frequency characteristics of the optical signal generated in the vicinity of a distance of 1 km of the optical fiber 10.

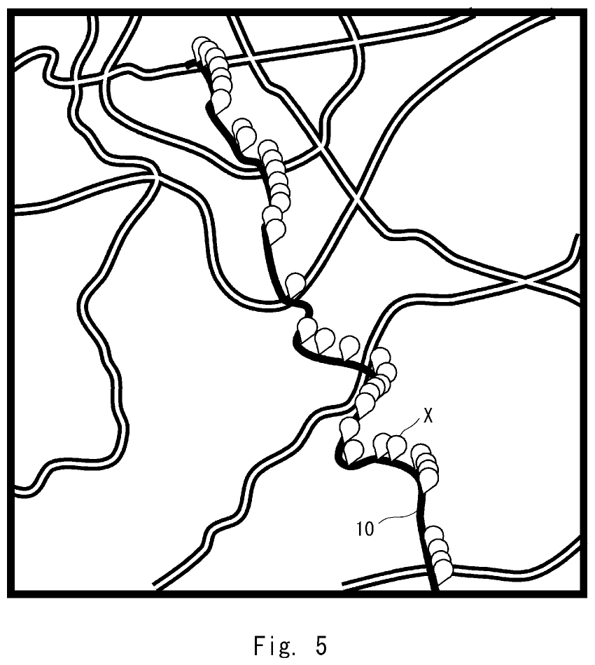

Herein, it is assumed that the vibration generation unit 32 generates vibration at a plurality of positions while being moved, the distance specifying unit 22 specifies the distance of the optical fiber 10 at each of the plurality of positions, and the position specifying unit 23 specifies two frequencies associated to the latitude and longitude of the current position of the vibration generator 30. FIG. 4 illustrates an example of the two frequencies associated to the latitude and longitude of the current position of the vibration generator 30, which are specified by the position specifying unit 23 in this case. In FIG. 4, the horizontal axis represents the distance of the optical fiber 10, and the vertical axis represents two frequencies associated to latitude and longitude.

In the example of FIG. 4, a frequency equal to or higher than a predetermined value is assigned to the first frequency associated to the latitude, and a frequency less than the predetermined value is assigned to the second frequency associated to the longitude. Accordingly, the first frequency and the second frequency are frequencies that do not overlap each other. Therefore, even if vibrations of two frequencies including the first frequency and the second frequency are simultaneously generated in the vibration generation unit 32, the position specifying unit 23 is able to specify the two frequencies.

Further, the position specifying unit 23 stores the distance and the position information of the optical fiber 10 at each of the plurality of locations in association with each other. Accordingly, the position specifying unit 23 is also capable of specifying an installation route of the optical fiber 10, based on the association. FIG. 5 illustrates an example of the installation route of the optical fiber 10 specified by the position specifying unit 23.

In the example of FIG. 5, the position at which the optical fiber 10 detects the vibration is indicated by reference numeral X. The position specifying unit 23 may plot a position at which the optical fiber 10 detects vibration on a map, and specify an installation route of the optical fiber 10, based on the plotted position.

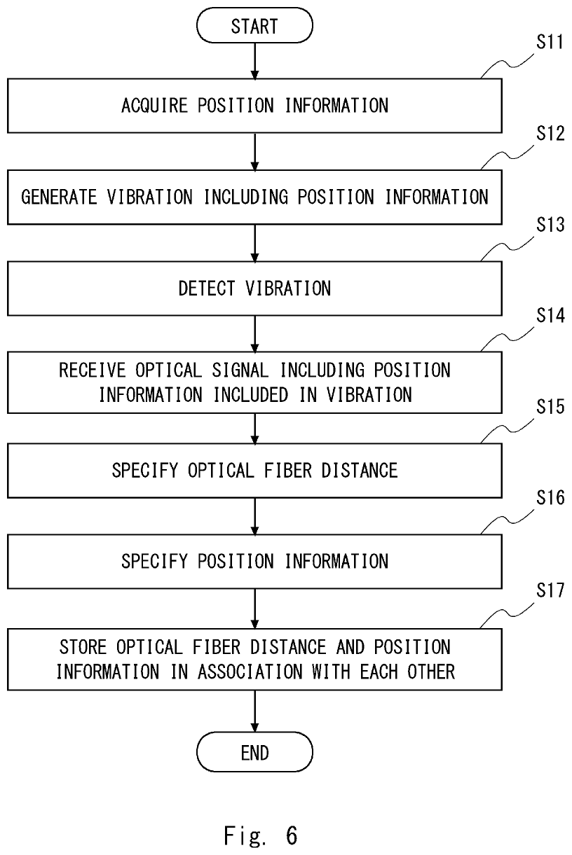

Next, with reference to FIG. 6, an example of a flow of the operation of the position specifying system according to the present example embodiment will be described.

As illustrated in FIG. 6, first, the position information acquisition unit 31 acquires, at any position, position information indicating the latitude and longitude of the current position of the vibration generator 30 (step S11). Then, the vibration generation unit 32 generates vibration including the position information acquired by the position information acquisition unit 31, and applies the generated vibration to the optical fiber 10 (step S12).

Then, the optical fiber 10 detects the vibration including the position information (step S13). Thus, an optical signal transmitted through the optical fiber 10 is caused to include the position information included in the vibration, and the communication unit 21 receives the resulting optical signal (step S14).

Then, the distance specifying unit 22 specifies the distance of the optical fiber 10 from the location of the sensing device 20 (the communication unit 21) to the location where the optical fiber 10 detects the vibration, based on the optical signal received by the communication unit 21 (step S15).

Thereafter, the position specifying unit 23 specifies, based on the optical signal received by the communication unit 21, the position information of the current position of the vibration generator 30 (step S16), and stores the specified position information and the distance of the optical fiber 10 specified by the distance specifying unit 22 in association with each other (step S17).

Note that the operation of FIG. 6 may be performed at each of a plurality of locations. In such a case, the position specifying unit 23 stores the distance of the optical fiber 10 at each of the plurality of locations and the position information of the vibration generator 30 in association with each other. Therefore, the position specifying unit 23 may specify an installation route of the optical fiber 10, based on the association.

As described above, according to the present example embodiment, the position information acquisition unit 31 acquires the position information of the current position of the vibration generator 30, and the vibration generation unit 32 generates vibration including the position information acquired by the position information acquisition unit 31, and applies the generated vibration to the optical fiber 10.

Thus, on the sensing device 20 side, the position information of the position where the optical fiber 10 detects the vibration is able to be acquired by detecting the vibration applied to the optical fiber 10. At this time, the sensing device 20 does not need to be time-synchronized with the vibration generator 30. Further, since the sensing device 20 does not need to transmit information to and from the vibration generator 30 via the network, a network environment is also unnecessary. Therefore, the sensing device 20 is able to easily acquire the position information of the installation position of the optical fiber 10.

### Other Example Embodiments

In the above-described example embodiment, the vibration generator 30 applies vibration of a frequency associated to position information of the current position to the optical fiber 10, but the present invention is not limited thereto. The vibration generator 30 may apply vibration of an amplitude associated to the position information of the current position to the optical fiber 10. Alternatively, the vibration generator 30 may apply, to the optical fiber 10, vibration of a combination pattern of amplitude states, such as generation and stop of vibration, associated to position information of the current position. Also, in the detection of the vibration position, the vibration pattern described above may be used in order to distinguish the vibration from external vibration, without being limited to amplitude intensity.

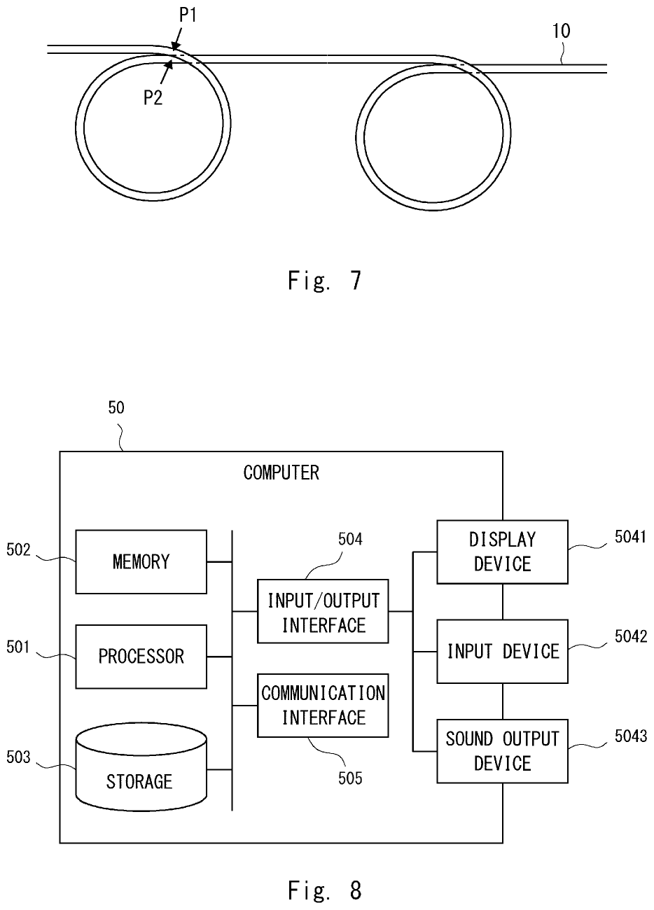

Further, in the above-described example embodiment, the position specifying unit 23 specifies the installation route of the optical fiber 10, based on the association between the distance of the optical fiber 10 at each of the plurality of locations and the position information of the vibration generator 30, but the present invention is not limited thereto. When the optical fiber 10 is being installed, an excess portion may be generated as illustrated in FIG. 7. Therefore, the position specifying unit 23 may specify the presence or absence of an excess portion of the optical fiber 10, based on the association between the distance of the optical fiber 10 at each of the plurality of locations and the position information of the vibration generator 30. For example, at positions P1 and P2 in the example of FIG. 7, although the position information will be substantially the same, the distance of the optical fiber 10 will be different. Therefore, the position specifying unit 23 specifies that there is an excess portion in the optical fiber 10.

Further, in the above-described example embodiment, the vibration generator 30 applies vibration including the position information of the current position to the optical fiber 10, but the present invention is not limited thereto. A sound generator may be provided in place of the vibration generator 30, and the sound generator may apply sound including position information to the optical fiber 10. For example, for an overhead optical fiber 10, it is easier to apply sound than to apply vibration.

### Hardware Configuration of Degradation Determination Apparatus According to Example Embodiments

FIG. 8 illustrates an example of a hardware configuration of a computer 50 that implements the sensing device 20 according to the above-described example embodiments.

As illustrated in FIG. 8, the computer 50 includes a processor 501, a memory 502, a storage 503, an input/output interface (input/output I/F) 504, a communication interface (communication I/F) 505, and the like. The processor 501, the memory 502, the storage 503, the input/output interface 504, and the communication interface 505 are connected by a data transmission path for transmitting and receiving data to and from each other.

The processor 501 is, for example, an arithmetic processing unit such as a central processing unit (CPU) or a graphics processing unit (GPU). The memory 502 is, for example, a memory such as a random access memory (RAM) or a read-only memory (ROM). The storage 503 is, for example, a storage device such as a hard disk drive (HDD), a solid state drive (SSD), or a memory card. The storage 503 may be a memory such as a RAM or a ROM.

The storage 503 stores programs for implementing the functions of the constituent elements included in the sensing device 20. The processor 501 implements the functions of each of the constituent elements included in the sensing device 20 by executing each of the programs. Herein, the processor 501 may execute each of the programs after developing the programs on the memory 502, or may execute the programs without developing them on the memory 502. Further, the memory 502 and the storage 503 also serve to store information and data held by the constituent elements included in the sensing device 20.

Further, the above-described programs may be stored by using various types of non-transitory computer readable media and supplied to a computer (including the computer 50). Non-transitory computer readable media include various types of tangible storage media. Examples of non-transitory computer readable media include magnetic recording media (e.g., flexible disk, magnetic tape, and hard disk drive), magneto-optical recording media (e.g., magneto-optical disk), compact disc-ROM (CD-ROM), CD-recordable (CD-R), CD-rewritable (CD-R/W), semiconductor memory (e.g., mask ROM, programmable ROM (PROM), erasable PROM (EPROM), flash ROM, and RAM). Further, the program may be supplied to the computer by various types of transitory computer readable media. Examples of transitory computer readable media include electrical signals, optical signals, and electromagnetic waves. The transitory computer readable medium is able to supply the program to the computer via a wired communication path such as an electric wire and an optical fiber, or a wireless communication path.

The input/output interface 504 is connected to a display device 5041, an input device 5042, a sound output device 5043, and the like. The display device 5041 is a device such as a liquid crystal display (LCD), a cathode ray tube (CRT) display, or a monitor that displays a screen relating to the drawing data processed by the processor 501. The input device 5042 is a device that receives an input operation from an operator, and is, for example, a keyboard, a mouse, a touch sensor, or the like. The display device 5041 and the input device 5042 may be integrated and implemented as a touch panel. The sound output device 5043 is a device, such as a speaker, that outputs sound relating to sound data processed by the processor 501.

The communication interface 505 transmits and receives data to and from an external device. For example, the communication interface 505 communicates with an external device via a wired communication path or a wireless communication path.

Note that, the vibration generator 30 according to the above-described example embodiments may also be implemented by the computer 50 having the hardware configuration illustrated in FIG. 8.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Some or all of the above-described example embodiments may be described as the following Supplementary notes, but are not limited thereto.

### (Supplementary Note 1)

A position specifying system comprising:
a position information acquisition unit configured to acquire position information;
a vibration generation unit configured to generate vibration including the position information;
an optical fiber configured to detect the vibration;
a communication unit configured to receive an optical signal including the position information included in the vibration;
a distance specifying unit configured to specify, based on the optical signal, a distance of the optical fiber from a location of the communication unit to a location where the optical fiber detects vibration; and
a position specifying unit configured to specify, based on the optical signal, the position information included in the optical signal and store the distance and the position information in association with each other.

### (Supplementary Note 2)

The position specifying system according to Supplementary Note 1, wherein
the vibration generation unit generates vibration of a frequency associated to the position information, and
the position specifying unit specifies a frequency of the vibration, based on the optical signal, and further specifies the position information included in the optical signal, based on the specified frequency.

### (Supplementary Note 3)

The position specifying system according to Supplementary Note 2, wherein
the position information represents latitude and longitude, and
the vibration generation unit simultaneously generates vibration of a first frequency associated to latitude and vibration of a second frequency associated to longitude.

### (Supplementary Note 4)

The position specifying system according to Supplementary Note 2, wherein
the position information represents latitude and longitude, and
the vibration generation unit generates vibration of a first frequency associated to latitude and vibration of a second frequency associated to longitude at different timings.

### (Supplementary Note 5)

The position specifying system according to any one of Supplementary Notes 1 to 4, wherein
the vibration generation unit generates the vibration at a plurality of locations,
the distance specifying unit specifies the distance at each of the plurality of locations, and
the position specifying unit specifies the position information at each of the plurality of locations, stores the distance and the position information of each of the plurality of locations in association with each other, and specifies an installation route of the optical fiber, based on the association between the distance and the position information of each of the plurality of locations.

### (Supplementary Note 6)

A vibration generator comprising:
a position information acquisition unit configured to acquire position information; and
a vibration generation unit configured to apply vibration including the position information to an optical fiber.

### (Supplementary Note 7)

The vibration generator according to Supplementary Note 6, wherein the vibration generation unit applies vibration of a frequency associated to the position information to the optical fiber.

### (Supplementary Note 8)

The vibration generator according to Supplementary Note 7, wherein
the position information represents latitude and longitude, and
the vibration generation unit simultaneously applies, to the optical fiber, vibration of a first frequency associated to latitude and vibration of a second frequency associated to longitude.

### (Supplementary Note 9)

The vibration generator according to Supplementary Note 7, wherein
the position information represents latitude and longitude, and
the vibration generation unit applies, to the optical fiber, vibration of a first frequency associated to latitude and vibration of a second frequency associated to longitude at different timings.

### (Supplementary Note 10)

A position specifying method to be performed by a position specifying system, the method comprising:
a step of acquiring position information;
a vibration generating step of generating vibration including the position information;
a step of detecting the vibration by use of an optical fiber;
a step of receiving an optical signal including the position information included in the vibration by use of a communication unit;
a distance specifying step of specifying, based on the optical signal, a distance of the optical fiber from a location of the communication unit to a location where the optical fiber detects vibration; and
a position specifying step of specifying, based on the optical signal, the position information included in the optical signal and storing the distance and the position information in association with each other.

### (Supplementary Note 11)

The position specifying method according to Supplementary Note 10, wherein
the vibration generating step includes generating vibration of a frequency associated to the position information, and
the position specifying step includes specifying a frequency of the vibration, based on the optical signal, and further specifying the position information included in the optical signal, based on the specified frequency.

### (Supplementary Note 12)

The position specifying method according to Supplementary Note 11, wherein
the position information represents latitude and longitude, and
the vibration generating step includes simultaneously generating vibration of a first frequency associated to latitude and vibration of a second frequency associated to longitude.

### (Supplementary Note 13)

The position specifying method according to Supplementary Note 11, wherein
the position information represents latitude and longitude, and
the vibration generating step includes generating vibration of a first frequency associated to latitude and vibration of a second frequency associated to longitude at different timings.

### (Supplementary Note 14)

The position specifying method according to any one of Supplementary Notes 10 to 13, wherein
the vibration generating step includes generating the vibration at a plurality of locations,
the distance specifying step includes specifying the distance at each of the plurality of locations, and
the position specifying step includes specifying the position information at each of the plurality of locations, storing the distance and the position information of each of the plurality of locations in association with each other, and specifying an installation route of the optical fiber, based on the association between the distance and the position information of each of the plurality of locations.

### REFERENCE SIGNS LIST

10 OPTICAL FIBER
20 SENSING DEVICE
21 COMMUNICATION UNIT
22 DISTANCE SPECIFYING UNIT
23 POSITION SPECIFYING UNIT
30 VIBRATION GENERATOR
31 POSITION INFORMATION ACQUISITION UNIT
32 VIBRATION GENERATION UNIT
50 COMPUTER
501 PROCESSOR
502 MEMORY
503 STORAGE
504 INPUT/OUTPUT INTERFACE
5041 DISPLAY DEVICE
5042 INPUT DEVICE
5043 SOUND OUTPUT DEVICE
505 COMMUNICATION INTERFACE

What is claimed is:

1. A position specifying system comprising:
a position information acquisition unit configured to acquire position information;
a vibration generation unit configured to generate vibration including the position information;
an optical fiber configured to detect the vibration;
a communication unit configured to receive an optical signal including the position information included in the vibration;
a distance specifying unit configured to specify, based on the optical signal, a distance of the optical fiber from a location of the communication unit to a location where the optical fiber detects vibration; and
a position specifying unit configured to specify, based on the optical signal, the position information included in the optical signal and store the distance and the position information in association with each other.

2. The position specifying system according to claim 1, wherein
the vibration generation unit generates vibration of a frequency associated to the position information, and
the position specifying unit specifies a frequency of the vibration, based on the optical signal, and further specifies the position information included in the optical signal, based on the specified frequency.

3. The position specifying system according to claim 2, wherein
the position information represents latitude and longitude, and
the vibration generation unit simultaneously generates vibration of a first frequency associated to latitude and vibration of a second frequency associated to longitude.

4. The position specifying system according to claim 2, wherein
the position information represents latitude and longitude, and
the vibration generation unit generates vibration of a first frequency associated to latitude and vibration of a second frequency associated to longitude at different timings.

5. The position specifying system according to claim 1, wherein
the vibration generation unit generates the vibration at a plurality of locations,
the distance specifying unit specifies the distance at each of the plurality of locations, and
the position specifying unit specifies the position information at each of the plurality of locations, stores the distance and the position information of each of the plurality of locations in association with each other, and specifies an installation route of the optical fiber, based on the association between the distance and the position information of each of the plurality of locations.

6. A vibration generator comprising:
at least one memory storing instructions,
at least one processor configured to execute the instructions to acquire position information; and
a vibration generation unit configured to apply vibration including the position information to an optical fiber.

7. The vibration generator according to claim 6, wherein the vibration generation unit applies vibration of a frequency associated to the position information to the optical fiber.

8. The vibration generator according to claim 7, wherein
the position information represents latitude and longitude, and
the vibration generation unit simultaneously applies, to the optical fiber, vibration of a first frequency associated to latitude and vibration of a second frequency associated to longitude.

9. The vibration generator according to claim 7, wherein
the position information represents latitude and longitude, and
the vibration generation unit applies, to the optical fiber, vibration of a first frequency associated to latitude and vibration of a second frequency associated to longitude at different timings.

10. A position specifying method to be performed by a position specifying system, the method comprising:
a step of acquiring position information;
a vibration generating step of generating vibration including the position information;
a step of detecting the vibration by use of an optical fiber;
a step of receiving an optical signal including the position information included in the vibration by use of a communication unit;
a distance specifying step of specifying, based on the optical signal, a distance of the optical fiber from a location of the communication unit to a location where the optical fiber detects vibration; and
a position specifying step of specifying, based on the optical signal, the position information included in the optical signal and storing the distance and the position information in association with each other.

11. The position specifying method according to claim 10, wherein
the vibration generating step includes generating vibration of a frequency associated to the position information, and
the position specifying step includes specifying a frequency of the vibration, based on the optical signal, and further specifying the position information included in the optical signal, based on the specified frequency.

12. The position specifying method according to claim 11, wherein
the position information represents latitude and longitude, and
the vibration generating step includes simultaneously generating vibration of a first frequency associated to latitude and vibration of a second frequency associated to longitude.

13. The position specifying method according to claim 11, wherein
the position information represents latitude and longitude, and
the vibration generating step includes generating vibration of a first frequency associated to latitude and vibration of a second frequency associated to longitude at different timings.

14. The position specifying method according to claim 10, wherein
the vibration generating step includes generating the vibration at a plurality of locations,
the distance specifying step includes specifying the distance at each of the plurality of locations, and
the position specifying step includes specifying the position information at each of the plurality of locations, storing the distance and the position information of each of the plurality of locations in association with each other, and specifying an installation route of the optical fiber, based on the association between the distance and the position information of each of the plurality of locations.
